(19) United States
(12) Patent Application Publication
(10) Pub. No.: US 2025/0105669 A1
(43) Pub. Date: Mar. 27, 2025

(54) DYNAMIC CAPACITANCE TUNING FOR WIRELESS POWER TRANSFER

(71) Applicant: Apple Inc., Cupertino, CA (US)

(72) Inventors: Jukka-pekka J Sjoeroos, Cupertino, CA (US); Weihong Qiu, San Ramon, CA (US)

(21) Appl. No.: 18/613,196

(22) Filed: Mar. 22, 2024

Related U.S. Application Data
(60) Provisional application No. 63/585,279, filed on Sep. 26, 2023.

(51) Int. Cl. H02J 50/12

(52) U.S. Cl. CPC H02J 50/12

(57) ABSTRACT

A method of operating a wireless power transmitter having a wireless power transmitting coil, an inverter that receives an input voltage and generates an AC output voltage that drives the wireless power transmitting coil, and at least one adjustable capacitance coupled to the wireless power transmitting coil to form a series tuning circuit therewith, can be performed by control circuitry of the wireless power transmitter and can include: responsive to increased power demand from a wireless power receiver, determining whether the input voltage is at a maximum value and, if so, reducing the at least one adjustable capacitance to increase gain; or responsive to decreased power demand from the wireless power receiver, determining whether the input voltage is at a minimum value and, if so, increasing the at least one adjustable capacitance to decrease gain.

### CROSS-REFERENCE TO RELATED APPLICATIONS

This application claims priority to U.S. Provisional Patent Application No. 63/585,279, filed Sep. 26, 2023, entitled “DYNAMIC CAPACITANCE TUNING FOR WIRELESS POWER TRANSFER,” which is incorporated by reference herein in its entirety for all purposes.

### BACKGROUND

Wireless power transfer has become increasingly popular in a wide variety of electronic devices. For example, many electronic devices, such as smart phones, tablet computers, smart watches, wireless earphones, styluses, etc. may employ wireless power transfer to facilitate charging of batteries within the devices. In some application, higher levels of wireless power transfer may be desired, for example to provide for faster charging. Such higher power transfer levels can benefit from techniques to tune various system parameters to improve operating efficiency, voltage regulation, and the like.

### SUMMARY

A wireless power transmitter can include: a wireless power transmitting coil; an inverter that receives an input voltage and generates an AC output voltage that drives the wireless power transmitting coil; at least one adjustable capacitance coupled to the wireless power transmitting coil to form a series tuning circuit therewith; and control circuitry that operates the inverter and the at least one adjustable capacitance to deliver wireless power to a wireless power receiver, wherein the control circuitry responds to power demand from the wireless power receiver by: determining whether the input voltage is at a maximum value and, if so, reducing the at least one adjustable capacitance to increase gain; or determining whether the input voltage is at a minimum value and, if so, increasing the at least one adjustable capacitance to decrease gain.

The at least one adjustable capacitance can include one or more capacitors selectively couplable to the wireless power transmitting coil by one or more switches controlled by the control circuitry. The at least one adjustable capacitance can include at least one capacitor coupled to the wireless power transmitting coil and at least two capacitors selectively couplable to the wireless power transmitting coil by one or more switches controlled by the control circuitry. Determining whether the input voltage is at a maximum value and, if so, reducing the at least one adjustable capacitance to increase gain can further include at least temporarily adjusting the input voltage prior to reducing the at least one adjustable capacitance. At least temporarily adjusting the input voltage prior to reducing the at least one adjustable capacitance can be responsive to an operating power level of the wireless power transmitter. Determining whether the input voltage is at a minimum value and, if so, increasing the at least one adjustable capacitance to decrease gain can further include at least temporarily adjusting the input voltage prior to increasing the at least one adjustable capacitance. At least temporarily adjusting the input voltage prior to increasing the at least one adjustable capacitance is responsive to an operating power level of the wireless power transmitter.

The wireless power transmitter can further include control circuitry that, responsive to one or more hard switching events, increasing the at least one adjustable capacitance to mitigate the hard switching events. The at least one adjustable capacitance can include: one or more capacitors selectively couplable between the inverter output and the wireless power transmitting coil by one or more first switches controlled by the control circuitry; and one or more capacitors selectively couplable between the inverter output and ground by one or more second switches controlled by the control circuitry. The one or more capacitors selectively couplable between the inverter output and the wireless power transmitting coil can include at least one capacitor coupled between the inverter output and the wireless power transmitting coil and at least two capacitors selectively couplable between the inverter output and the wireless power transmitting coil by the one or more first switches. The one or more capacitors selectively couplable between the inverter output and ground can include at least one capacitor coupled between the inverter output and ground and a plurality of capacitors selectively couplable between the inverter output and ground by the one or more second switches. The wireless power transmitter can further include control circuitry that, responsive to an absence of one or more hard switching events, decreases the at least one adjustable capacitance to mitigate the hard switching events.

A method of operating a wireless power transmitter having a wireless power transmitting coil, an inverter that receives an input voltage and generates an AC output voltage that drives the wireless power transmitting coil, and at least one adjustable capacitance coupled to the wireless power transmitting coil to form a series tuning circuit therewith, can be performed by control circuitry of the wireless power transmitter and can include: responsive to increased power demand from a wireless power receiver, determining whether the input voltage is at a maximum value and, if so, reducing the at least one adjustable capacitance to increase gain; or responsive to decreased power demand from the wireless power receiver, determining whether the input voltage is at a minimum value and, if so, increasing the at least one adjustable capacitance to decrease gain.

Determining whether the input voltage is at a maximum value and, if so, reducing the at least one adjustable capacitance to increase gain can further include at least temporarily adjusting the input voltage prior to reducing the at least one adjustable capacitance. Determining whether the input voltage is at a minimum value and, if so, increasing the at least one adjustable capacitance to decrease gain can further include at least temporarily adjusting the input voltage prior to increasing the at least one adjustable capacitance.

The method can further include, responsive to one or more hard switching events, increasing the at least one adjustable capacitance to mitigate the hard switching events and, responsive to an absence of one or more hard switching events, decreasing the at least one adjustable capacitance to mitigate the hard switching events.

A wireless power receiver can include: a wireless power receiving coil; a rectifier that receives an AC voltage induced in the wireless power receiving coil by a wireless power transmitter and generates a DC output voltage therefrom; at least one adjustable capacitance coupled to the wireless power receiving coil to form a series tuning circuit therewith; and control circuitry that operates the rectifier and the at least one adjustable capacitance to deliver power to a load coupled to the DC output voltage of the rectifier. The control circuitry can respond to power demand by: determining whether a DC input voltage of an inverter of the wireless power transmitter is at a maximum value and, if so, reducing the at least one adjustable capacitance to increase gain; or determining whether the DC input voltage of the inverter of the wireless power transmitter is at a minimum value and, if so, increasing the at least one adjustable capacitance to decrease gain. The DC input voltage can be determined by the control circuitry responsive to one or more messages received from the wireless power transmitter.

The at least one adjustable capacitance can include one or more capacitors selectively couplable to the wireless power receiving coil by one or more switches controlled by the control circuitry. The at least one adjustable capacitance can include at least one capacitor coupled between the wireless power receiving coil and the rectifier at least one capacitor selectively couplable between the wireless power receiving coil and the rectifier by one or more switches controlled by the control circuitry.

Determining whether the DC input voltage of the inverter is at a maximum value and, if so, reducing the at least one adjustable capacitance to increase gain further can include, responsive to rectifier power, at least temporarily reducing the rectifier power prior to reducing the at least one adjustable capacitance. Determining whether the DC input voltage of the inverter is at a minimum value and, if so, increasing the at least one adjustable capacitance to decrease gain can further include, responsive to rectifier power, at least temporarily reducing the rectifier power prior to increasing the at least one adjustable capacitance.

A method of operating a wireless power receiver having a wireless power receiving coil, a rectifier that receives an AC voltage induced in the wireless power receiving coil by a wireless power transmitter and generates a DC output voltage therefrom, and at least one adjustable capacitance coupled to the wireless power receiving coil to form a series tuning circuit therewith, can be performed by control circuitry of the wireless power receiver and can include: responsive to increased power demand, determining whether a DC input voltage of an inverter of the wireless power transmitter is at a maximum value and, if so, reducing the at least one adjustable capacitance to increase gain; or responsive to decreased power demand, determining whether the DC input voltage of the inverter of the wireless power transmitter is at a minimum value and, if so, increasing the at least one adjustable capacitance to decrease gain; wherein the DC input voltage is determined by the control circuitry responsive to one or more messages received from the wireless power transmitter.

Determining whether the DC input voltage of the inverter is at a maximum value and, if so, reducing the at least one adjustable capacitance to increase gain can further include, responsive to rectifier power, at least temporarily reducing the rectifier power prior to reducing the at least one adjustable capacitance. Determining whether the DC input voltage of the inverter is at a minimum value and, if so, increasing the at least one adjustable capacitance to decrease gain can further include, responsive to rectifier power, at least temporarily reducing the rectifier power prior to increasing the at least one adjustable capacitance.

### BRIEF DESCRIPTION OF THE DRAWINGS

FIG. 1 illustrates a simplified block diagram of a wireless power transfer system.

FIGS. 2A-2E illustrate schematic diagrams of a wireless power transfer system.

FIGS. 3A-3C illustrate flow charts of a wireless power transmitter capacitance tuning technique.

FIG. 4 illustrates a flow chart of a wireless power receiver capacitance tuning technique.

### DETAILED DESCRIPTION

In the following description, for purposes of explanation, numerous specific details are set forth to provide a thorough understanding of the disclosed concepts. As part of this description, some of this disclosure's drawings represent structures and devices in block diagram form for sake of simplicity. In the interest of clarity, not all features of an actual implementation are described in this disclosure. Moreover, the language used in this disclosure has been selected for readability and instructional purposes, has not been selected to delineate or circumscribe the disclosed subject matter. Rather the appended claims are intended for such purpose.

Various embodiments of the disclosed concepts are illustrated by way of example and not by way of limitation in the accompanying drawings in which like references indicate similar elements. For simplicity and clarity of illustration, where appropriate, reference numerals have been repeated among the different figures to indicate corresponding or analogous elements. In addition, numerous specific details are set forth to provide a thorough understanding of the implementations described herein. In other instances, methods, procedures, and components have not been described in detail so as not to obscure the related relevant function being described. References to “an,” “one,” or “another” embodiment in this disclosure are not necessarily to the same or different embodiment, and they mean at least one. A given figure may be used to illustrate the features of more than one embodiment, or more than one species of the disclosure, and not all elements in the figure may be required for a given embodiment or species. A reference number, when provided in a given drawing, refers to the same element throughout the several drawings, though it may not be repeated in every drawing. The drawings are not to scale unless otherwise indicated, and the proportions of certain parts may be exaggerated to better illustrate details and features of the present disclosure.

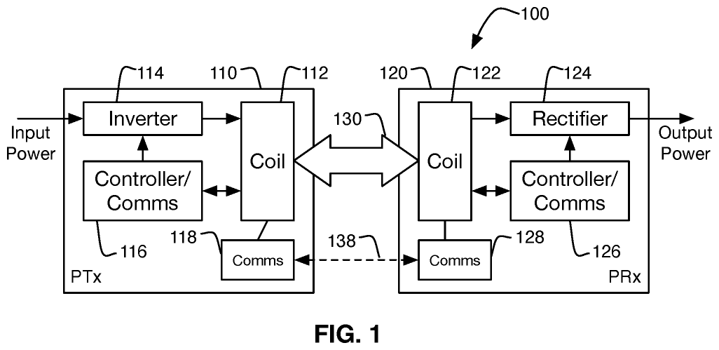

FIG. 1 illustrates a simplified block diagram of a wireless power transfer system 100. Wireless power transfer system includes a power transmitter (PTx) 110 that transfers power to a power receiver (PRx) 120 wirelessly, such as via inductive coupling 130. Power transmitter 110 may receive input power that is converted to an AC voltage having particular voltage and frequency characteristics by an inverter 114. Inverter 114 may be controlled by a controller/communications module 116 that operates as further described below. In various embodiments, the inverter controller and communications module may be implemented in a common system, such as a system based on a microprocessor, microcontroller, or the like. In other embodiments, the inverter controller may be implemented by a separate controller module and communications module that have a means of communication between them. Inverter 114 may be constructed using any suitable circuit topology (e.g., full bridge, half bridge, etc.) and may be implemented using any suitable semiconductor switching device technology (e.g., MOSFETs, IGBTs, etc. made using silicon, silicon carbide, or gallium nitride devices).

Inverter 114 may deliver the generated AC voltage to a transmitter coil 112. In addition to a wireless coil allowing magnetic coupling to the receiver, the transmitter coil block 112 illustrated in FIG. 1 may include tuning circuitry, such as additional inductors and capacitors, that facilitate operation of the transmitter in different conditions, such as different degrees of magnetic coupling to the receiver, different operating frequencies, etc. The wireless coil itself may be constructed in a variety of different ways. In some embodiments, the wireless coil may be formed as a winding of wire around a suitable bobbin. In other embodiments, the wireless coil may be formed as traces on a printed circuit board. Other arrangements are also possible and may be used in conjunction with the various embodiments described herein. The wireless transmitter coil may also include a core of magnetically permeable material (e.g., ferrite) configured to affect the flux pattern of the coil in a way suitable to the particular application. The teachings herein may be applied in conjunction with any of a wide variety of transmitter coil arrangements appropriate to a given application.

PTx controller/communications module 116 may monitor the transmitter coil and use information derived therefrom to control the inverter 114 as appropriate for a given situation. For example, controller/communications module may be configured to cause inverter 114 to operate at a given frequency or output voltage depending on the particular application. In some embodiments, the controller/communications module may be configured to receive information from the PRx device and control inverter 114 accordingly. This information may be received via the power transmission coils (i.e., in-band communication) or may be received via a separate communications channel (not shown, i.e., out-of-band communication). For in-band communication, controller/communications module 116 may detect and decode signals imposed on the magnetic link (such as voltage, frequency, or load variations) by the PRx to receive information and may instruct the inverter to modulate the delivered power by manipulating various parameters of the generated voltage (such as voltage, frequency, etc.) to send information to the PRx. In some embodiments, controller/communications module may be configured to employ frequency shift keying (FSK) communications, in which the frequency of the inverter signal is modulated, to communicate data to the PRx. Controller/communications module 116 may be configured to detect amplitude shift keying (ASK) communications or load modulation-based communications from the PRx. In either case, the controller/communications module 126 may be configured to vary the current drawn on the receiver side to manipulate the waveform seen on the Tx coil to deliver information from the PRx to the PTx. For out-of-band communication, additional modules that allow for communication between the PTx and PRx may be provided, for example, WiFi, Bluetooth, or other radio links or any other suitable communications channel.

As mentioned above, controller/communications module 116 may be a single module, for example, provided on a single integrated circuit, or may be constructed from multiple modules/devices provided on different integrated circuits or a combination of integrated and discrete circuits having both analog and digital components. The teachings herein are not limited to any particular arrangement of the controller/communications circuitry.

PTx device 110 may optionally include other systems and components, such as a separate communications module 118. In some embodiments, comms module 118 may communicate with a corresponding module in the PRx via the power transfer coils. In other embodiments, comms module 118 may communicate with a corresponding module using a separate physical channel 138.

As noted above, wireless power transfer system also includes a wireless power receiver (PRx) 120. Wireless power receiver can include a receiver coil 122 that may be magnetically coupled 130 to the transmitter coil 112. As with transmitter coil 112 discussed above, receiver coil block 122 illustrated in FIG. 1 may include tuning circuitry, such as additional inductors and capacitors, that facilitate operation of the transmitter in different conditions, such as different degrees of magnetic coupling to the receiver, different operating frequencies, etc. The wireless coil itself may be constructed in a variety of different ways. In some embodiments, the wireless coil may be formed as a winding of wire around a suitable bobbin. In other embodiments, the wireless coil may be formed as traces on a printed circuit board. Other arrangements are also possible and may be used in conjunction with the various embodiments described herein. The wireless receiver coil may also include a core of magnetically permeable material (e.g., ferrite) configured to affect the flux pattern of the coil in a way suitable to the particular application. The teachings herein may be applied in conjunction with any of a wide variety of receiver coil arrangements appropriate to a given application.

Receiver coil 122 outputs an AC voltage induced therein by magnetic induction via transmitter coil 112. This output AC voltage may be provided to a rectifier 124 that provides a DC output power to one or more loads associated with the PRx device. Rectifier 124 may be controlled by a controller/communications module 126 that operates as further described below. In various embodiments, the rectifier controller and communications module may be implemented in a common system, such as a system based on a microprocessor, microcontroller, or the like. In other embodiments, the rectifier controller may be implemented by a separate controller module and communications module that have a means of communication between them. Rectifier 124 may be constructed using any suitable circuit topology (e.g., full bridge, half bridge, etc.) and may be implemented using any suitable semiconductor switching device technology (e.g., MOSFETs, IGBTs, etc. made using silicon, silicon carbide, or gallium nitride devices).

PRx controller/communications module 126 may monitor the receiver coil and use information derived therefrom to control the rectifier 124 as appropriate for a given situation. For example, controller/communications module may be configured to cause rectifier 124 to operate provide a given output voltage depending on the particular application. In some embodiments, the controller/communications module may be configured to send information to the PTx device to effectively control the power delivered to the receiver. This information may be received sent via the power transmission coils (i.e., in-band communication) or may be sent via a separate communications channel (not shown, i.e., out-of-band communication). For in-band communication, controller/communications module 126 may, for example, modulate load current or other electrical parameters of the received power to send information to the PTx. In some embodiments, controller/communications module 126 may be configured to detect and decode signals imposed on the magnetic link (such as voltage, frequency, or load variations) by the PTx to receive information from the PTx. In some embodiments, controller/communications module 126 may be configured to receive frequency shift keying (FSK) communications, in which the frequency of the inverter signal has been modulated to communicate data to the PRx. Controller/communications module 126 may be configured to generate amplitude shift keying (ASK) communications or load modulation-based communications from the PRx. In either case, the controller/communications module 126 may be configured to vary the current drawn on the receiver side to manipulate the waveform seen on the Tx coil to deliver information from the PRx to the PTx. For out-of-band communication, additional modules that allow for communication between the PTx and PRx may be provided, for example, WiFi, Bluetooth, or other radio links or any other suitable communications channel.

As mentioned above, controller/communications module 126 may be a single module, for example, provided on a single integrated circuit, or may be constructed from multiple modules/devices provided on different integrated circuits or a combination of integrated and discrete circuits having both analog and digital components. The teachings herein are not limited to any particular arrangement of the controller/communications circuitry. PRx device 120 may optionally include other systems and components, such as a communications (“comms”) module 128. In some embodiments, comms module 128 may communicate with a corresponding module in the PTx via the power transfer coils. In other embodiments, comms module 128 may communicate with a corresponding module or tag using a separate physical channel 138.

Numerous variations and enhancements of the above-described wireless power transmission system 100 are possible, and the following teachings are applicable to any of such variations and enhancements.

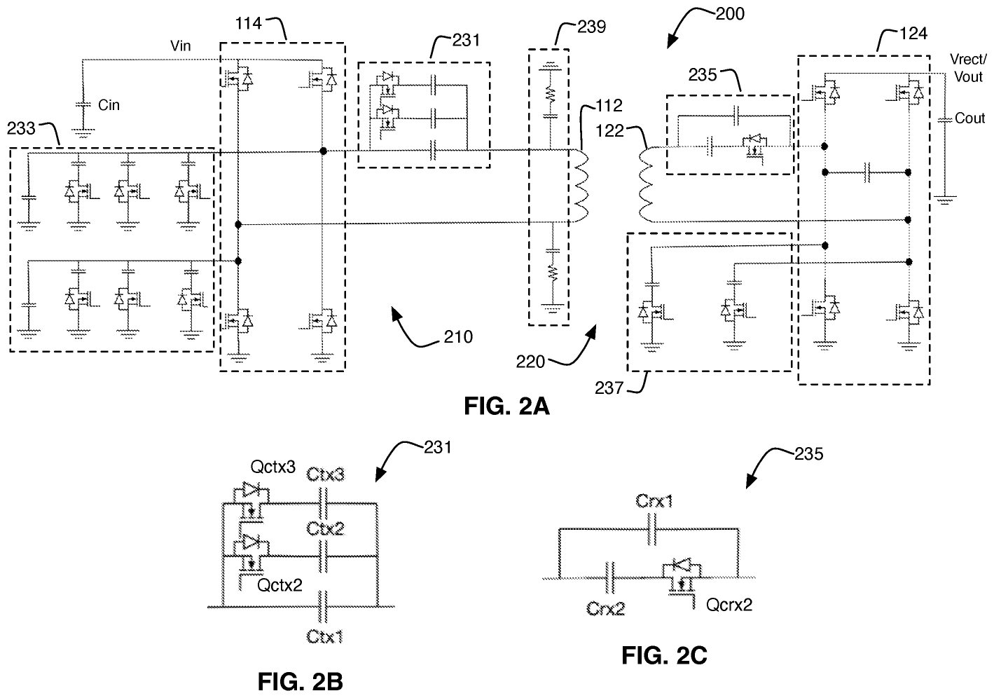

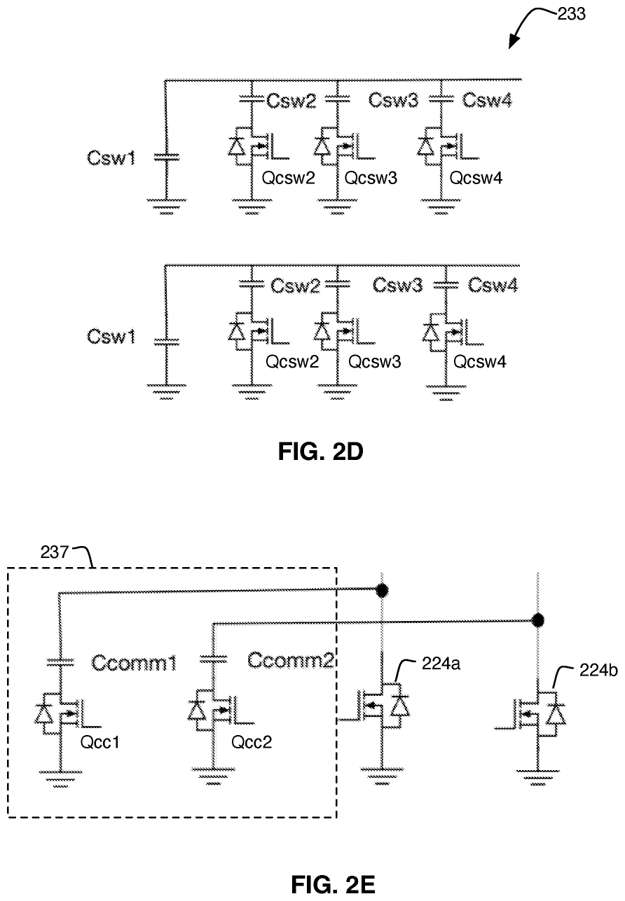

FIGS. 2A-2E illustrate schematic diagrams of a wireless power transfer system. FIG. 2A illustrates an overall schematic 200 of a wireless power transfer system including a wireless power transmitter (PTx) 210 and a wireless power receiver 220, like those with similar reference numbers (e.g., PTx 110 and PRx 120) described above with respect to FIG. 1. Wireless power transmitter 210 can include an inverter 114 that can drive transmitter coil 112. Inverter 114 is depicted as a full bridge inverter, although other inverter configurations could be used depending on application requirements. Inverter 114 can receive input voltage Vin from an input voltage source, represented by capacitor Cin, which could include any suitable DC power source, such as a battery, a DC-DC converter, an AC-DC converter, etc. Inverter 114 can drive transmitter coil 112 via series tuning network 231, described in greater detail below with respect to FIG. 2B. Also depicted in FIG. 2A is optional slew rate tuning circuitry 233 described in greater detail below with respect to FIG. 2D. FIG. 2B also depicts parasitic elements 239, which can represent the effects of various wireless charger system implementations, such as a capacitance associated with a wire/cord, etc. The illustrated representation is but one example, and other representations may be more appropriate depending on the exact physical configuration of a particular implementation.

FIG. 2A also depicts wireless power receiver 220. Wireless power receiver 220 can include a rectifier that can be driven receiver coil 122, which can have a current induced therein by transmitter coil 112. Rectifier 124 is depicted as a full bridge rectifier, although other rectifier configurations could be used depending on application requirements. Rectifier 124 can produce an output voltage Vrect/Vout from the AC voltage appearing across receiver coil 122. Rectifier 124 can be driven via series tuning circuit 235, described in greater detail below with respect to FIG. 2C. Also depicted in FIG. 2A is in band communication circuitry 237 described in greater detail below with respect to FIG. 2E.

FIG. 2B depicts a schematic diagram of wireless power transmitter series tuning circuit 231 introduced above with reference to FIG. 2A. The transmitter series tuning circuit can include a capacitance, such as capacitors Ctx1, Ctx2, and Ctx3, together with the inductance of transmitter coil 112. Depending on various parameters, such as amount of power being transferred, operating voltages, degree of coupling between PTx and PRx, etc., it may be desirable to tune the series tuning circuit to improve overall operation. For example, as described in greater detail below, it may be desirable to adjust the series tuning circuit to change a gain of the wireless power transfer system, allowing adaptation to various input voltages, power levels, etc.

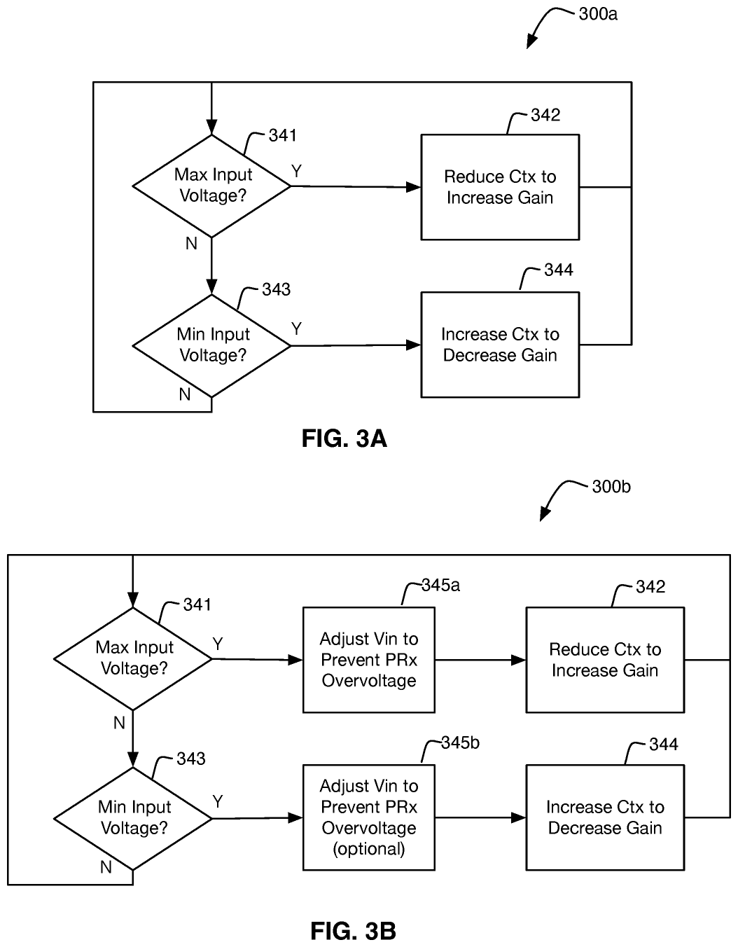

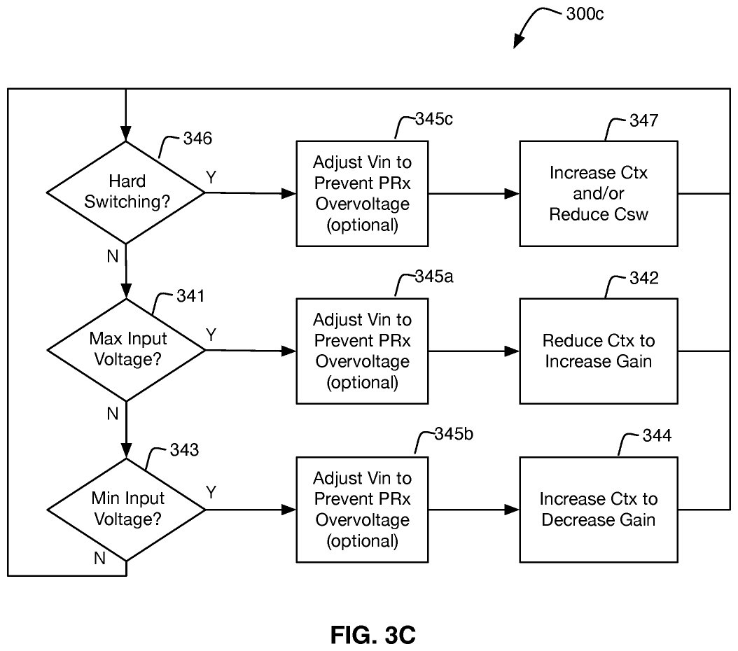

Series tuning circuit 231 can include the base capacitance of capacitor Ctx1, which can always be present in the series tuning circuit, and selectable capacitance from capacitors Ctx2 and Ctx3. These capacitors can be selectively connected in parallel with capacitor Ctx1 to increase the effective capacitance by closing switches Qctx2 and/or Qctx3, respectively. Correspondingly, if one or more of switches Qctx2 and Qctx3 is closed, connecting the corresponding capacitor(s) into the series tuning circuit, then opening such switches can decrease the capacitance of the series tuning circuit. By selecting different values for the respective capacitors, a range of capacitances can be provided. Switches Qctx2 and Qctx3 can be controlled by the wireless power transmitter controller/comms circuitry 116, described above with respect to FIG. 1. Such control can implement one or more of the control techniques described below with respect to FIGS. 3A-3C. The configuration of FIG. 2B is merely exemplary, and other configurations including additional selective capacitors, all selectable capacitors, series combinations of capacitors (to selectively reduce capacitance), etc. can all be implemented if appropriate for a given application.

FIG. 2C depicts a schematic diagram of wireless power receiver series tuning circuit 235 introduced above with reference to FIG. 2A. The receiver series tuning circuit can include a capacitance, such as capacitors Crx1 and Crx2 together with the inductance of receiver coil 122. Depending on various parameters, such as amount of power being transferred, operating voltages, degree of coupling between PTx and PRx, etc., it may be desirable to tune the series tuning circuit to improve overall operation. For example, as described in greater detail below, it may be desirable to adjust the series tuning circuit to change a gain of the wireless power transfer system, allowing adaptation to various input voltages, power levels, etc.

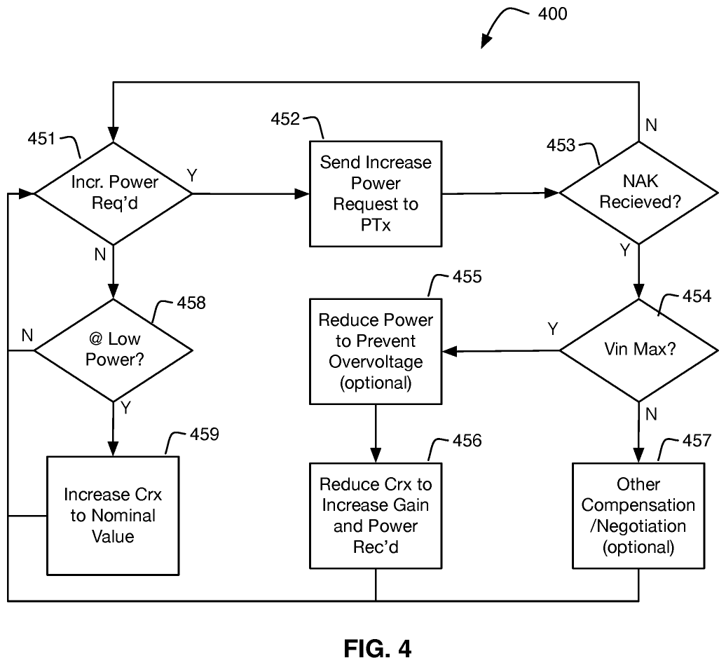

Series tuning circuit 235 can include the base capacitance of capacitor Crx1, which can always be present in the series tuning circuit, and selectable capacitance from capacitor Crx2. This capacitor can be selectively connected in parallel with capacitor Ctx1 to increase the effective capacitance by closing switch Qcrx2. Correspondingly, if switch Qcrx2 is closed, connecting the corresponding capacitor(s) into the series tuning circuit, then opening such switch can decrease the capacitance of the series tuning circuit. By selecting different values for the respective capacitors, a range of capacitances can be provided. Switch Qcrx2 can be controlled by the wireless power receiver controller/comms circuitry 126, described above with respect to FIG. 1. Such control can implement a control technique such as that described below with respect to FIG. 4. The configuration of FIG. 2C is merely exemplary, and other configurations including additional selective capacitors, all selectable capacitors, series combinations of capacitors (to selectively reduce capacitance), etc. can all be implemented if appropriate for a given application.

FIG. 2D illustrates optional slew rate tuning circuitry 233 introduced above with respect to FIG. 2A. For improved operating efficiency, it may be preferable to operate inverter 114 with zero voltage switching (ZVS), which can reduce switching losses associated with inverter operation. Depending on various parameters, such as operating voltage, operating power level, etc., ZVS may not be possible for a given inverter circuit configuration, including without limitation the overall capacitance coupled to the inverter. To allow for ZVS over a wider operating range, slew rate tuning circuitry 233 can be provided. More specifically, if one or more hard switching events (i.e., a lack of ZVS) are detected, the capacitance can be reduced. Alternatively, if, over a given time period, no hard switching events are detected (potentially corresponding to a larger than necessary ZVS margin), then the capacitance can be increased, which can increase the voltage slew rate of the inverter.

The slew rate tuning circuitry can include the base capacitance of capacitor Csw1, which can always be present, and selectable capacitance from capacitors Csw2, Csw3, and Csw4. These capacitors can be selectively connected in parallel with capacitor Csw1 to increase the effective capacitance by closing switches Qcsw2, Qcsw3, and Qcsw4. Correspondingly, if one or more of switch Qcrx2 is closed, connecting the corresponding capacitor(s) into the series tuning circuit, then opening such switch can decrease the capacitance of the series tuning circuit. Corresponding slew rate capacitors and associated switches can be connected to each inverter leg, as depicted in FIG. 2A. By selecting different values for the respective capacitors, a range of capacitances can be provided. Switches Qcsw2, Qcsw3, and Qcsw4 can be controlled by the wireless power transmitter controller/comms circuitry 116, described above with respect to FIG. 1. Such control can implement various control techniques depending on the implementation. In some embodiments, the slew rate capacitance can be tuned in conjunction with changes to the series tuning capacitance, as described in greater detail below. The configuration of FIG. 2D is merely exemplary, and other configurations including additional selective capacitors, all selectable capacitors, series combinations of capacitors (to selectively reduce capacitance), etc. can all be implemented if appropriate for a given application.

FIG. 2E illustrates in band communication circuitry 237 introduced above with respect to FIG. 2A. In band communication circuitry 237 is but one example of a wide variety of in band communication circuitry types, associated with corresponding in band communication methods. In many embodiments, various forms of load modulation may be employed. Such load modulation can be used to implement amplitude switched keying (“ASK”) communications, in which connection or disconnection of additional load elements can be used to change the power received, which can be detected by the transmitter with respect to corresponding changes in power transmitted. As one example, in band communication circuitry 237 includes switches Qcc1 and Qcc2 that can selectively couple/de-couple capacitors Ccomm1 and Ccomm2 to/from respective legs of (full bridge) rectifier 124, represented in FIG. 2E by switches 224a and 224b. This configuration is but one example, and numerous other configurations of such circuitry could be implemented.

FIGS. 3A-3C illustrate flow charts of a wireless power transmitter capacitance tuning technique. The PTx input voltage Vin (FIG. 2A) can vary to regulate the output power of the inverter and thus the power delivered to a wireless power receiver. Increasing the input voltage Vin can increase the delivered power and vice-versa. Thus, the wireless power transmitter can regulate the delivered power by changing the input voltage Vin, e.g., by modifying a control signal provided to a DC-DC converter supplying the input voltage. Depending on the output voltage provided as Vin, and the power level being requested by the wireless power receiver, it is possible that the system can end up operating in a region where output voltage regulation to the desired level becomes difficult or impossible. This can be overcome in at least come conditions by adjusting the series tuning capacitance, for example using circuitry as described above with reference to FIGS. 2A-2B.

FIG. 3A illustrates a flow chart 300a of a high-level wireless power transmitter capacitance tuning technique. Beginning at block 341, the transmitter controller (e.g., controller/comms circuitry 116) can determine whether the input voltage Vin has reached a maximum value (i.e., a high threshold). This may occur, for example, in response to a request for a power increase from a wireless power receiver when the wireless power transmitter is already operating at its maximum input voltage. If so, the controller can reduce Ctx to increase the gain of the wireless power transfer system (block 342), while continuing to monitor the input voltage. Reducing Ctx can be achieved, for example, by opening one or more of switches Qctx2, Qctx3 (FIG. 2B) to disconnect one or more of the selectable capacitors Ctx2, Ctx3 coupled to the transmitter coil. If in block 341, the transmitter controller determines that the input voltage is not at a maximum value/high threshold, the controller can determine, in block 343, whether the input voltage has reached a minimum value (i.e., a low threshold). This may occur, for example, in response to a decrease in or a request to decrease the transmitted wireless power. If so, the controller can increase Ctx to decrease the gain of the wireless power transfer system (block 344), while continuing to monitor the input voltage. Increasing Ctx can be achieved, for example, by closing one or more of switches Qctx2, Qctx3 (FIG. 2B) to couple one or more of the selectable capacitors Ctx2, Ctx3 to the transmitter coil. Thus, the transmitter controller can regulate or adjust the input voltage as well as the series tuning capacitance responsive to power demand from a wireless power receiver.

As described above, different capacitance values may be achieved by different combinations of capacitors Ctxn. Moreover, different numbers of resonant capacitors Ctxn could be provided, and each capacitor could have a different capacitance value (or the same capacitance value). The system can thus be designed to provide any of a range of capacitance values responsive to the input voltage.

FIG. 3B illustrates a flow chart 300b of a modified wireless power transmitter capacitance tuning technique with optional additional steps that may be advantageous in various conditions, such as relatively higher transferred power levels. As before, at block 341, the transmitter controller (e.g., controller/comms circuitry 116) can determine whether the input voltage Vin has reached a maximum value (i.e., a high threshold), e.g., in response to increased power demand from a wireless power receiver. If so, the controller can first adjust (e.g., reduce) Vin (block 345a), possibly at least temporarily reducing the transferred power level, before making any changes to the series tuning capacitance. Adjusting the input voltage prior to changing the input capacitance can prevent overvoltage events from occurring at the wireless power receiver because of the transmitter-side capacitance change. Subsequently, the controller can reduce Ctx to increase the gain of the wireless power transfer system (block 342), while continuing to monitor the input voltage. As described above, reducing Ctx can be achieved, for example, by opening one or more of switches Qctx2, Qctx3 (FIG. 2B) to disconnect one or more of the selectable capacitors Ctx2, Ctx3 coupled to the transmitter coil. The transferred power level may then again increase to a relatively higher value, for example, if a higher power level is requested by the wireless power receiver.

Alternatively, if in block 341, the transmitter controller determines that the input voltage is not at a maximum value/high threshold, the controller can determine, in block 343, whether the input voltage has reached a minimum value (i.e., a low threshold), e.g., in response to decreased power demand by the wireless power receiver. If so, the controller (optionally) can first adjust Vin (block 345b), possibly at least temporarily reducing the transferred power level, before making any changes to the series tuning capacitance. As described above, adjusting the input voltage (and the associated transferred power level) prior to changing the input capacitance can prevent overvoltage events from occurring at the wireless power receiver because of the transmitter-side capacitance change. Subsequently, the controller can increase Ctx to decrease the gain of the wireless power transfer system (block 344), while continuing to monitor the input voltage. Increasing Ctx can be achieved, for example, by closing one or more of switches Qctx2, Qctx3 (FIG. 2B) to couple one or more of the selectable capacitors Ctx2, Ctx3 to the transmitter coil. The transferred power level may then again increase to a relatively higher value, for example, if a higher power level is requested by the wireless power receiver.

The above-described input voltage adjustments can be achieved in various ways. For example, in at least some embodiments, the voltage adjustment could be achieved by altering a feedback control signal provided to a DC-DC converter or other regulator providing Vin. In other embodiments, such as those in which the input voltage is supplied by a USB-PD power adapter, suitable USB-PD control signals could be provided to the adapter to change the provided voltage.

As described above, certain operating regimes, e.g., higher power levels, may call for the adjustment of input voltage prior to making transmitter-side capacitance changes, while other operating regimes, e.g., lower transmitted power levels, may not necessarily benefit from such operations. Thus, the techniques described above could be modified to selectively provide the input voltage adjustment before capacitor switching responsive to the transmitted power level. As one example, the input voltage adjustment function could be enabled responsive to the power level being above a first threshold power level and disabled responsive to the power level being below a second threshold power level. The first and second threshold power levels could be the same value or could be different values, providing a degree of hysteresis in the operation.

FIG. 3C illustrates a flow chart 300c of a further modified wireless power transmitter capacitance tuning technique with optional additional steps that may be advantageous to address inverter hard switching (i.e., non-ZVS) events that can lead to increased losses and decreased operating efficiency. Beginning with block 346, the control circuitry can determine whether hard switching conditions are present. This may be the occurrence of a single hard switching event, or more preferably in at least some cases, detection of multiple hard switching events within a period of time and/or multiple consecutive hard switching events. Such hard switching event(s) can indicate an opportunity to improve operating efficiency by increasing the capacitance coupled to the inverter, which can include adjustment of either the series tuning capacitance Ctx and/or adjustment of an optional slew rate tuning capacitance as described above with respect to FIG. 3D.

In any case, if a hard switching condition is detected, the controller can increase the series tuning capacitance (block 347) or adjust both the slew rate capacitance Csw and the series tuning capacitance Ctx to provide an overall increase in capacitance. For example, the adjustment could include increasing the slew rate capacitance Csw and decreasing the series tuning capacitance Ctx while still providing an overall capacitance increase. Additionally (and potentially optionally), the controller can adjust the input voltage Vin (block 345c) before changing the capacitance to prevent receiver-side overvoltage events (as described above). Not shown in FIG. 3C is a procedure for decreasing the capacitance if the conditions leading to a preceding hard switching triggered capacitance are no longer present. Such changes could be made, for example, by detecting that no hard switching event has been detected for a period of time. The system could then reduce the capacitance (by adjusting the series tuning capacitance Ctx and/or the slew rate capacitance Csw). If the reduction triggers hard switching events, the capacitance adjustment could be undone (i.e., the capacitance again increased). Alternatively, if the reduction does not trigger hard switching conditions, the capacitance reduction could be maintained.

Otherwise, if hard switching conditions do not trigger a capacitance adjustment in block 346, the technique depicted in flowchart 300c can be like that described above with reference to FIGS. 3A and 3B. As before, at block 341, the transmitter controller (e.g., controller/comms circuitry 116) can determine whether the input voltage Vin has reached a maximum value (i.e., a high threshold), e.g., in response to increased power demand from a wireless power receiver. If so, the controller can (optionally, e.g., responsive to transferred power level) first adjust (reduce because already at maximum voltage) Vin (block 345a), also at least temporarily reducing the transferred power level, before making any changes to the series tuning capacitance. Adjusting (e.g., reducing) the input voltage prior to changing the input capacitance can prevent overvoltage events from occurring at the wireless power receiver because of the transmitter-side capacitance change. Subsequently, the controller can reduce Ctx to increase the gain of the wireless power transfer system (block 342), while continuing to monitor the input voltage. As described above, reducing Ctx can be achieved, for example, by opening one or more of switches Qctx2, Qctx3 (FIG. 2B) to disconnect one or more of the selectable capacitors Ctx2, Ctx3 coupled to the transmitter coil. The transferred power level may then again increase to a relatively higher value, for example, if a higher power level is requested by the wireless power receiver.

Alternatively, if in block 341, the transmitter controller determines that the input voltage is not at a maximum value/high threshold, the controller can determine, in block 343, whether the input voltage has reached a minimum value (i.e., a low threshold), e.g., in response to reduced power demand from a wireless power receiver. If so, the controller can (optionally, e.g., responsive to transferred power level) first adjust (increase because already at minimum voltage) Vin (block 345b), also potentially temporarily reducing the transferred power level, before making any changes to the series tuning capacitance. As described above, adjusting (increasing) the input voltage (and the associated transferred power level) prior to changing the input capacitance can prevent overvoltage events from occurring at the wireless power receiver because of the transmitter-side capacitance change. Subsequently, the controller can increase Ctx to decrease the gain of the wireless power transfer system (block 344), while continuing to monitor the input voltage. Increasing Ctx can be achieved, for example, by closing one or more of switches Qctx2, Qctx3 (FIG. 2B) to couple one or more of the selectable capacitors Ctx2, Ctx3 to the transmitter coil. The transferred power level may then again increase to a relatively higher value, for example, if a higher power level is requested by the wireless power receiver.

Described above are various techniques for adjusting wireless power transmitter series tuning capacitance in response to input voltage and load conditions to achieve improved voltage regulation. Additionally or alternatively, series tuning capacitance adjustments can also be performed on the wireless power receiver side to achieve similar effects. FIG. 4 illustrates a flow chart of a wireless power receiver capacitance tuning technique 400 in which the receiver-side resonant gain associated with the receiver side resonant circuit including the receiver coil and series tuning capacitance Crx is tuned based on power level and transmitter-side input voltage. Beginning with block 451, the receiver controller (e.g., receiver controller/comms circuitry 126) can determine whether increased power is required or desired. If so, in block 452, the receiver controller can send an increased power request to the wireless power transmitter (PTx). If the PTx can send an increased power level, it can do so, e.g., by increasing its input voltage Vin. Otherwise, if the PTx is not capable of sending an increased power level, it can communicate this to the wireless power receiver, e.g., by sending a NAK (not acknowledged) message in response to the request from the receiver for increased power. This NAK message (and the preceding message from the receiver requesting increased power may be in accordance with one or more standard protocols, such as the Qi wireless charging standards promulgated by the Wireless Power Consortium or can be in any other format suitable for communication between PTx and PRx, such as a proprietary protocol.

If the NAK message is not received (block 453) then power will be increased by the PTx, and the process can return to block 451. Otherwise, if a NAK message is received (block 453), then the receiver controller can determine whether the PTx is unable to send increased power because it is already at its maximum input voltage Vin. For example, the NAK message received from the PTx may include an indication of why increased power is not available (e.g., because the PTx is already at max input voltage) or may be followed by a subsequent message indicating such information. If the NAK message indicates a reason it is unable to provide increased power other than it already being at its maximum input voltage, then the receiver may optionally engage in other compensation or negotiation with the PTx (block 457) to attempt to increase the received power, with control returning to block 451 thereafter. Such other compensation or negotiation is beyond the scope of this application and is therefore not discussed in detail.

If the NAK message is received (block 453) and the reason for the NAK is that the PTx has reached its maximum input voltage Vin (block 454), then the receiver controller can reduce the receiver side series tuning capacitance Crx to increase gain and thus power received (block 456). Prior to doing so, the receiver controller can optionally reduce its power level to prevent overvoltage (block 455). This is analogous to the transmitter side process described above. In certain operating regimes, e.g., relatively higher power levels, a change in series tuning capacitance to increase gain and thus received power could cause an overvoltage event on the receiver side. To mitigate this, a temporary reduction in power prior to making the capacitance change can be implemented. Then, the power level can subsequently be increased after the capacitance change. The capacitance change on the receiver side can be made in a similar manner to that on the transmitter side, with one or more additional receiver side resonant capacitors Crx2 being optionally decoupled from the receiver coil 122 by opening switch Qcrx2 to decrease the capacitance, thereby increasing the gain and thus power received in block 456. Control can subsequently return to block 451.

If in block 451 the receiver controller determines that no increase in the wirelessly power transmitter is required or desired, then the receiver controller can determine whether it is at a low power level (block 458). If not, control can return to block 451. Otherwise, if the receiver controller determines that the receiver is operating at a low power level (block 458), then the receiver controller can increase the receiver series tuning capacitance back to a nominal value. The increase in capacitance can be achieved by closing switch Qcrx2 to couple resonant capacitor in parallel with capacitor Crx1, thereby increasing the capacitance and decreasing the gain of the system. As with the transmitter side adjustments, the power levels associated with increasing or decreasing the capacitance can be associated with one or more threshold power levels, which can be the same value or can be different values allowing for hysteresis in the transitions.

All of the operations described above refer to various voltage levels and thresholds, power levels and thresholds, etc. The teachings herein may be applied to various systems operating at different voltage levels, different power levels, etc. For example, in some embodiments, the input voltage may be controllable to be in a range between about 16V and 20V, whether by manipulation of the control signal for a DC-DC converter or otherwise. Such a voltage range may, but need not, correspond to a USB-PD power source providing a 20V input voltage to such DC-DC converter. However, operation in other voltage ranges corresponding to other USB-PD voltage levels may also be appropriate. For example, an input voltage range between about 10V and 15V or 12V and 15V may be used with a 15V USB-PD supply. Alternatively, if a buck-boost converter were used to provide Vin from the power source, the top of the supplied voltage range could go above the voltage supplied to such DC-DC converter. Similarly, with respect to power thresholds, a 15 W power threshold may serve as the demarcation between a low power regime and a higher power regime. Operating above this threshold could be used to selectively enable or disable functionality such as the input voltage reduction before initiating a change in capacitance on either the PTx or PRx side. However, 15 W is just one example of such a threshold, and this threshold could be 10 W, 12 W, 16 W, 18 W, 20 W, 22 W, 25 W, 28 W, 30 W, 32 W, 35 W, 38 W, 40 W, 45 W, 50 W, or any other suitable value. If a degree of hysteresis is desired, an additional power threshold could be used to indicate the return to a low power regime. Such a threshold might be 9 W, although any value less than the high power threshold could be used, such as a value of 12 W, 10 W, 7.5 W, 5 W, etc. Unless otherwise specified herein or in the appended claims any of the above-described values could be employed; however, for at least some applications, there may be advantageous reasons to employ certain specific thresholds.

Described above are various features and embodiments relating to dynamic capacitance tuning in wireless power transfer systems. Such arrangements may be used in a variety of applications but may be particularly advantageous when used in conjunction with electronic devices such as mobile phones, tablet computers, laptop or notebook computers, and accessories, such as wireless headphones, styluses, etc. Additionally, although numerous specific features and various embodiments have been described, it is to be understood that, unless otherwise noted as being mutually exclusive, the various features and embodiments may be combined various permutations in a particular implementation. Thus, the various embodiments described above are provided by way of illustration only and should not be constructed to limit the scope of the disclosure. Various modifications and changes can be made to the principles and embodiments herein without departing from the scope of the disclosure and without departing from the scope of the claims.

The foregoing describes exemplary embodiments of wireless power transfer systems that are able to transmit certain information between the PTx and PRx in the system. The present disclosure contemplates this passage of information improves the devices' ability to provide wireless power signals to each other in an efficient manner to facilitate battery charging, such as by sharing of the devices' power handling capabilities with one another. Entities implementing the present technology should take care to ensure that, to the extent any sensitive information is used in particular implementations, that well-established privacy policies and/or privacy practices are complied with. In particular, such entities would be expected to implement and consistently apply privacy practices that are generally recognized as meeting or exceeding industry or governmental requirements for maintaining the privacy of users. Implementers should inform users where personally identifiable information is expected to be transmitted in a wireless power transfer system and allow users to “opt in” or “opt out” of participation. For instance, such information may be presented to the user when they place a device onto a power transmitter, if the power transmitter is configured to poll for sensitive information from the power receiver.

Risk can be minimized by limiting the collection of data and deleting data once it is no longer needed. In addition, and when applicable, data de-identification can be used to protect a user's privacy. For example, a device identifier may be partially masked to convey the power characteristics of the device without uniquely identifying the device. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy. Robust encryption may also be utilized to reduce the likelihood that communication between inductively coupled devices are spoofed.

1. A wireless power transmitter comprising:
a wireless power transmitting coil;
an inverter that receives an input voltage and generates an AC output voltage that drives the wireless power transmitting coil;
at least one adjustable capacitance coupled to the wireless power transmitting coil to form a series tuning circuit therewith; and
control circuitry that operates the inverter and the at least one adjustable capacitance to deliver wireless power to a wireless power receiver, wherein the control circuitry responds to power demand from the wireless power receiver by:
determining whether the input voltage is at a maximum value and, if so, reducing the at least one adjustable capacitance to increase gain; or
determining whether the input voltage is at a minimum value and, if so, increasing the at least one adjustable capacitance to decrease gain.

2. The wireless power transmitter of claim 1 wherein the at least one adjustable capacitance includes one or more capacitors selectively couplable to the wireless power transmitting coil by one or more switches controlled by the control circuitry.

3. The wireless power transmitter of claim 2 wherein the at least one adjustable capacitance includes at least one capacitor coupled to the wireless power transmitting coil and at least two capacitors selectively couplable to the wireless power transmitting coil by one or more switches controlled by the control circuitry.

4. The wireless power transmitter of claim 1 wherein determining whether the input voltage is at a maximum value and, if so, reducing the at least one adjustable capacitance to increase gain further comprises at least temporarily adjusting the input voltage prior to reducing the at least one adjustable capacitance.

5. The wireless power transmitter of claim 4 wherein at least temporarily adjusting the input voltage prior to reducing the at least one adjustable capacitance is performed by the control circuitry responsive to an operating power level of the wireless power transmitter.

6. The wireless power transmitter of claim 1 wherein determining whether the input voltage is at a minimum value and, if so, increasing the at least one adjustable capacitance to decrease gain further comprises at least temporarily adjusting the input voltage prior to increasing the at least one adjustable capacitance.

7. The wireless power transmitter of claim 6 wherein at least temporarily adjusting the input voltage prior to increasing the at least one adjustable capacitance is responsive to an operating power level of the wireless power transmitter.

8. The wireless power transmitter of claim 1 wherein the control circuitry, responsive to one or more hard switching events, increases the at least one adjustable capacitance to mitigate the hard switching events.

9. The wireless power transmitter of claim 8 wherein the at least one adjustable capacitance includes:
one or more capacitors selectively couplable between the inverter output and the wireless power transmitting coil by one or more first switches controlled by the control circuitry; and
one or more capacitors selectively couplable between the inverter output and ground by one or more second switches controlled by the control circuitry.

10. The wireless power transmitter of claim 9 wherein:
the one or more capacitors selectively couplable between the inverter output and the wireless power transmitting coil include at least one capacitor coupled between the inverter output and the wireless power transmitting coil and at least two capacitors selectively couplable between the inverter output and the wireless power transmitting coil by the one or more first switches; and
the one or more capacitors selectively couplable between the inverter output and ground include at least one capacitor coupled between the inverter output and ground and a plurality of capacitors selectively couplable between the inverter output and ground by the one or more second switches.

11. The wireless power transmitter of claim 8 wherein the control circuitry, responsive to an absence of one or more hard switching events, decreases the at least one adjustable capacitance to mitigate the hard switching events.

12. A method of operating a wireless power transmitter having a wireless power transmitting coil, an inverter that receives an input voltage and generates an AC output voltage that drives the wireless power transmitting coil, and at least one adjustable capacitance coupled to the wireless power transmitting coil to form a series tuning circuit therewith, the method being performed by control circuitry of the wireless power transmitter and comprising:
responsive to increased power demand from a wireless power receiver, determining whether the input voltage is at a maximum value and, if so, reducing the at least one adjustable capacitance to increase gain; or
responsive to decreased power demand from the wireless power receiver, determining whether the input voltage is at a minimum value and, if so, increasing the at least one adjustable capacitance to decrease gain.

13. The method of claim 12 wherein determining whether the input voltage is at a maximum value and, if so, reducing the at least one adjustable capacitance to increase gain further comprises at least temporarily adjusting the input voltage prior to reducing the at least one adjustable capacitance.

14. The method of claim 12 wherein determining whether the input voltage is at a minimum value and, if so, increasing the at least one adjustable capacitance to decrease gain further comprises at least temporarily adjusting the input voltage prior to increasing the at least one adjustable capacitance.

15. The method of claim 12 further comprising, responsive to one or more hard switching events, increasing the at least one adjustable capacitance to mitigate the hard switching events.

16. The method of claim 15 further comprising, responsive to an absence of one or more hard switching events, decreasing the at least one adjustable capacitance to mitigate the hard switching events.

17. A wireless power receiver comprising:
a wireless power receiving coil;
a rectifier that receives an AC voltage induced in the wireless power receiving coil by a wireless power transmitter and generates a DC output voltage therefrom;
at least one adjustable capacitance coupled to the wireless power receiving coil to form a series tuning circuit therewith; and
control circuitry that operates the rectifier and the at least one adjustable capacitance to deliver power to a load coupled to the DC output voltage of the rectifier, wherein the control circuitry responds to power demand by:
determining whether a DC input voltage of an inverter of the wireless power transmitter is at a maximum value and, if so, reducing the at least one adjustable capacitance to increase gain; or
determining whether the DC input voltage of the inverter of the wireless power transmitter is at a minimum value and, if so, increasing the at least one adjustable capacitance to decrease gain;
wherein the DC input voltage is determined by the control circuitry responsive to one or more messages received from the wireless power transmitter.

18. The wireless power receiver of claim 17 wherein the at least one adjustable capacitance includes one or more capacitors selectively couplable to the wireless power receiving coil by one or more switches controlled by the control circuitry.

19. The wireless power receiver of claim 18 wherein the at least one adjustable capacitance includes at least one capacitor coupled between the wireless power receiving coil and the rectifier by one or more switches controlled by the control circuitry.

20. The wireless power receiver of claim 17 wherein determining whether the DC input voltage of the inverter is at a maximum value and, if so, reducing the at least one adjustable capacitance to increase gain further comprises, responsive to rectifier power, at least temporarily the rectifier power prior to reducing the at least one adjustable capacitance.

21. The wireless power receiver of claim 17 wherein determining whether the DC input voltage of the inverter is at a minimum value and, if so, increasing the at least one adjustable capacitance to decrease gain further comprises, responsive to rectifier power, at least temporarily reducing the rectifier power prior to increasing the at least one adjustable capacitance.

22. A method of operating a wireless power receiver having a wireless power receiving coil, a rectifier that receives an AC voltage induced in the wireless power receiving coil by a wireless power transmitter and generates a DC output voltage therefrom, and at least one adjustable capacitance coupled to the wireless power receiving coil to form a series tuning circuit therewith, the method being performed by control circuitry of the wireless power receiver and comprising:
responsive to increased power demand, determining whether a DC input voltage of an inverter of the wireless power transmitter is at a maximum value and, if so, reducing the at least one adjustable capacitance to increase gain; or
responsive to decreased power demand, determining whether the DC input voltage of the inverter of the wireless power transmitter is at a minimum value and, if so, increasing the at least one adjustable capacitance to decrease gain;
wherein the DC input voltage is determined by the control circuitry responsive to one or more messages received from the wireless power transmitter.

23. The method of claim 22 wherein determining whether the DC input voltage of the inverter is at a maximum value and, if so, reducing the at least one adjustable capacitance to increase gain further comprises, responsive to rectifier power, at least temporarily reducing the rectifier power prior to reducing the at least one adjustable capacitance.

24. The method of claim 22 wherein determining whether the DC input voltage of the inverter is at a minimum value and, if so, increasing the at least one adjustable capacitance to decrease gain further comprises, responsive to rectifier power, at least temporarily reducing the rectifier power prior to increasing the at least one adjustable capacitance.
